(19) United States
(12) Patent Application Publication
(10) Pub. No.: US 2026/0094055 A1
(43) Pub. Date: Apr. 2, 2026

(54) INDUSTRIAL MACHINE LEARNING OPERATIONS WITH INTEGRATED TRAINING, DEPLOYMENT, AND DATA MAINTENANCE

(71) Applicant: Rockwell Automation Technologies, Inc., Mayfield Heights, OH (US)

(72) Inventors: Brandon Lee, Mountain View, CA (US); Dongzuo Tian, Austin, TX (US); Alexander Berman, Austin, TX (US)

(21) Appl. No.: 18/902,112

(22) Filed: Sep. 30, 2024

(51) Int. Cl. G06N 20/00

(52) U.S. Cl. CPC G06N 20/00

(57) ABSTRACT

The present disclosure describes a machine learning operations platform that integrates training, deployment, and data maintenance for machine learning models in industrial automation environments. The machine learning operations platform provides processed data from the industrial environment to a machine learning model trained to detect anomalies in the industrial automation environment. The machine learning operations platform stores the processed data in a feature store for subsequent model retraining. The machine learning model utilizes a relational database schema that associates machine learning models with training data according to some implementations.

### BACKGROUND

Machine learning models are increasingly being used in industrial environments to enhance various operations, including predictive maintenance, process optimization, and quality control. Unlike traditional deterministic systems, which are designed for predictability and consistency, machine learning models exhibit a degree of stochastic behavior due to factors such as data drift (the change in input data distribution over time) and model drift (the evolution of the relationship between input data and output predictions). The predictable nature of traditional industrial systems means that the frameworks used for them are not suited for the adaptable requirements of machine learning models. A lack of accepted industry standards for machine learning operations results in erratic deployment practices by data scientists, leading to inconsistencies and challenges in maintaining model reliability and performance.

Furthermore, challenges arise from the siloing of data in existing industrial systems, which hampers the ability to effectively update models and evaluate their performance. For example, disconnects may exist between industrial data in the model development environment and industrial data in the runtime environment. This lack in interoperability often results in redundant data processing and reliance on manual processes, introducing the risk of errors. Additionally, existing cloud-centric machine learning operations platforms are not adequately tailored to the specific needs of industrial automation environments. For example, cloud-centric platforms may fail to meet the latency, security, and reliability requirements of machine learning operation tasks.

### SUMMARY

The present disclosure describes a machine learning operations architecture with seamless training, deployment, and data maintenance for machine learning models in an industrial automation environment. The architecture includes providing processed data to machine learning models for real-time inferences and storing the processed data in a feature store to be utilized for model retraining. The machine learning operations platform also stores versions of machine learning models in a model store, allowing for backup, recovery, and evaluation. The feature store is associated with the model store in a relational database schema that integrates data maintenance in the production and training environments.

One example of a computer-implemented method performed according to some implementations includes receiving a continuous stream of data from an industrial device executing an industrial process in an industrial automation environment. The method further includes processing the continuous stream of data to generate processed data. The processing comprises preparing the continuous stream of data for ingestion by a first machine learning model. The method further includes detecting anomalies in the continuous stream of data. Detecting the anomalies includes submitting the processed data to the first machine learning model trained to detect the anomalies in the industrial automation environment. The first machine learning model is stored in a model store. The method further includes storing the processed data in a feature store. The method further includes receiving training annotations for the processed data. The method further includes retraining, using the processed data from the feature store and the training annotations, the first machine learning model to generate a second machine learning model. The method further includes storing the second machine learning model in the model store. The model store is associated with the feature store in a relational database schema. The second machine learning model is associated with the processed data in the relational database schema.

These and other features and aspects of various examples may be understood in view of the following detailed discussion and accompanying drawings.

### BRIEF DESCRIPTION OF THE DRAWINGS

FIG. 1 illustrates a machine learning operations architecture in an implementation.

FIG. 2 illustrates a machine learning operations process in an implementation.

FIG. 3 illustrates an industrial automation environment in an implementation.

FIG. 4 illustrates a model retraining environment in an implementation.

FIG. 5 illustrates a relational database schema in an implementation.

FIG. 6 illustrates another industrial automation environment in an implementation.

FIG. 7 illustrates another model retraining environment in an implementation.

FIG. 8 illustrates another relational database schema in an implementation.

FIG. 9 illustrates a computing system suitable for implementing the various operational environments, architectures, environments, processes, scenarios, sequences, and frameworks discussed below with respect to the other figures.

### DETAILED DESCRIPTION

Machine learning models are used in industrial automation environments to provide insights about industrial processes. For example, factories may utilize anomaly detection models for early detection of potential problems in the industrial environment. Some anomaly detection models (e.g., GuardianAI by Rockwell) analyze runtime data received from industrial devices to detect potential issues in industrial processes (e.g., pump cavitation). Other anomaly detection models may process imagery from the industrial automation environment to detect anomalies (e.g., to identify malfunctioning equipment or defective products). Since industrial environments are dynamic, these machine learning models are particularly susceptible to model degradation due to data drift and model drift. For example, changes in the environment (e.g., seasonal changes in ambient temperature), changes in sensor equipment, and changes in output requirements may all contribute to a degradation in performance of machine learning models.

These models are frequently adapted and refined to maintain performance standards, which is a process involving a vast amount of data. The raw data gathered from industrial devices is processed for ingestion into the machine learning models (which may include, for example, generating feature vectors for input into the models). Upon ingestion, the machine learning models generate inferences, which may be, for example, anomaly detection parameters. Furthermore, the processed data is annotated for training purposes. Existing systems lack robust frameworks that effectively integrate all this data. For example, particularly where a machine learning operations platform is cloud-based, disconnects may exist between the model training environment and the model deployment environment. This creates process inefficiencies, for example, where raw data is processed separately for the deployment and training environments. Furthermore, performance monitoring becomes difficult where data is siloed, as data associated with the production model (i.e., a model deployed to make real-time inferences about the industrial environment) is separate from data associated with past versions of the model. The process of evaluating the production model against previous model versions becomes cumbersome, for example, where a data scientist needs to manually retrieve data from disparate locations in order to compare performances of various models.

Furthermore, cloud-based machine learning operations platforms present challenges, particularly in the context of industrial automation. Firstly, latency issues arise due to the time required to transfer large volumes of data from the industrial environment to cloud servers. This can be critical in industrial environments where real-time analysis and decision-making are essential. Furthermore, reliability is a significant concern. Dependence on continuous internet connectivity means that any network disruption can halt data flow and processing, leading to potential downtime and loss of operational efficiency. Finally, cloud-based systems may not seamlessly integrate with on-premises infrastructure.

The present disclosure describes a machine learning operations system designed to alleviate the above-described issues by integrating training, deployment, monitoring, and data maintenance. This platform processes raw data from industrial environments (e.g., runtime data or imagery) for ingestion into a primary machine learning model (i.e., the production model) to make inferences about the industrial automation environment. The processed data is stored in a feature store, facilitating its use for subsequent retraining of the primary model. This approach ensures that the same processed data can be utilized for both deployment and training, thereby reducing the need to reprocess data for model retraining.

Additionally, the system includes a comprehensive model store that maintains the production model alongside previous versions. This model store also archives inferences made by the models and training annotations used during model development. By employing a relational database schema, the platform effectively relates these models and their associated data. This schema links the processed data in the feature store with various versions of the models and their inferences, creating an interconnected and easily navigable repository. The relational database schema enhances efficiency and traceability, allowing systems and users to seamlessly access and compare different model versions, review past inferences, and analyze training annotations. This centralized and structured storage enhances the ability to iteratively update the models in the industrial environment.

The system can be implemented in a computing system on-premises within the industrial environment. Deploying the system on-premises provides enhanced security, reduces latency, and enables real-time processing and decision-making with respect to model updates. Additionally, maintaining the system on-site facilitates easier integration with on-premises systems (e.g., industrial devices and production machine learning models operating on edge servers), ensuring seamless data flow and interoperability.

The machine learning operations system described herein optimizes resource usage. As noted above, processing power is reduced by using processed data for both training and production-model inferences. Additionally, by consolidating training and deployment environments, the platform may reduce the need for redundant data storage and processing infrastructure, thereby saving on hardware and maintenance costs. Further, the tight coupling of the training and production systems helps ensure resource-optimized and time-efficient improvements to production systems without undue human intervention.

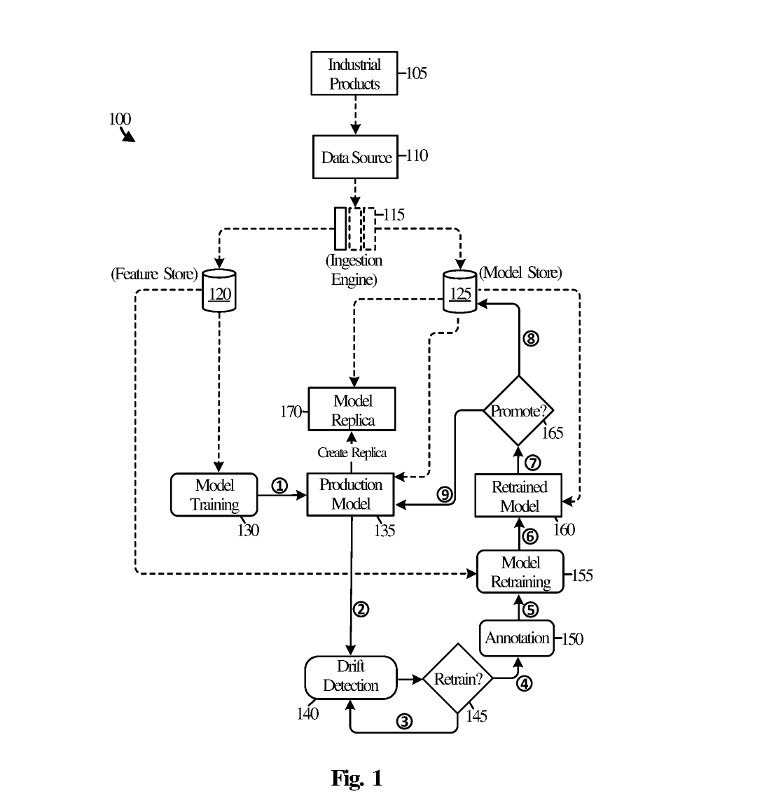

FIG. 1 illustrates machine learning operations system 100 in an implementation. Machine learning operations system 100 includes a framework with process flows to deploy and maintain machine learning models (e.g., GuardianAI by Rockwell) in industrial automation environments. Machine learning operations system 100 includes industrial products 105, data source 110, ingestion engine 115, feature store 120, model store 125, model training 130, production model 135, drift detection 140, retraining decision 145, annotation 150, model retraining 155, retrained model 160, promotion decision 165, and model replica 170.

Industrial products 105 are devices and machinery (e.g., pumps, fans, valves, conveyors, motors, cameras etc.) that operate and generate raw data in an industrial environment. The raw data generated by industrial products 105 may include sensor data, imagery, event logs, usage statistics, energy consumption data, and other operational data. The data generated by industrial products may be processed (as described further below) and utilized by production ML model 135 to detect anomalies in the industrial environment. For example, where industrial products 105 include a pump, production ML model 135 may identify that the pump has a risk of cavitation based on pressure data generated by the pump. Raw data generated by industrial products 105 is provided to data source 110. During runtime, industrial products 105 may continuously generate raw data (e.g., sensor data and camera imagery) and provide the raw data to data source 110.

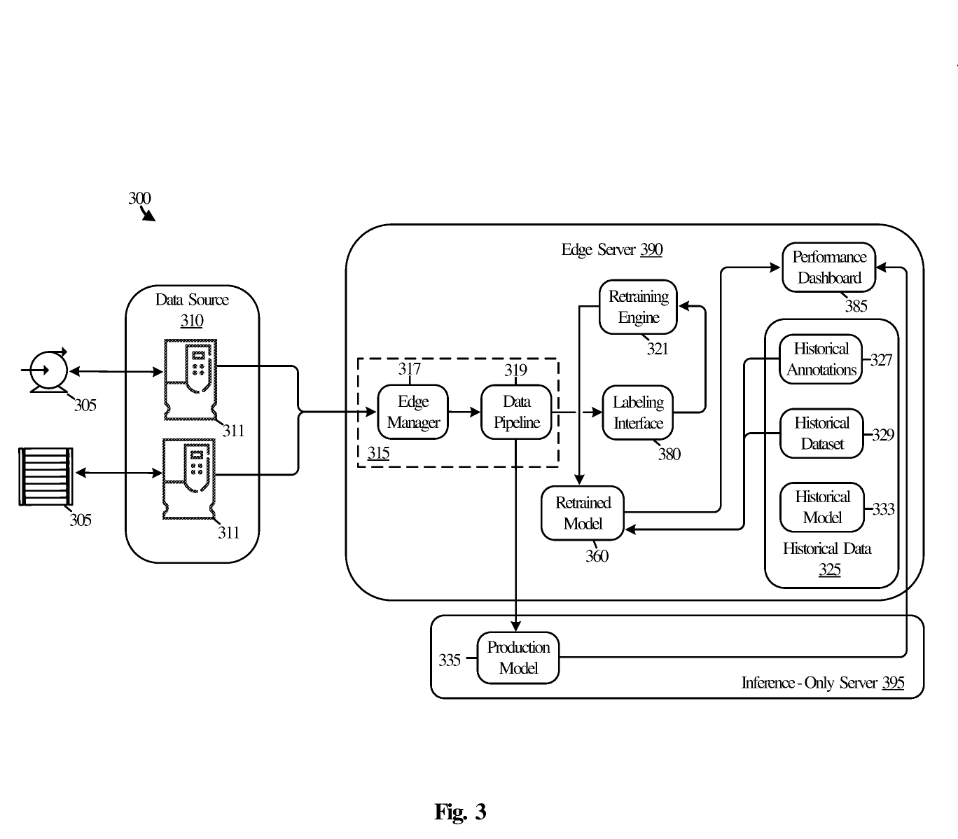

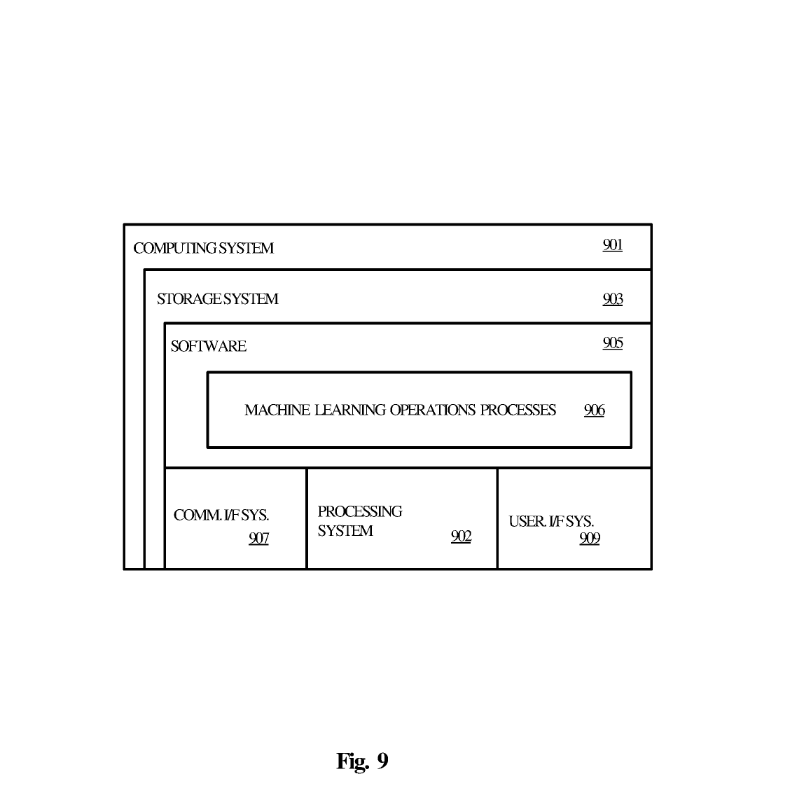

Data source 110 includes one or more devices operating in an industrial environment. Data source 110 may include control components such as motor drives or programmable logic controllers (PLCs) in some implementations. Data source 110 may include one or more devices (such as industrial devices 311 of FIG. 3) configured to receive the raw data from industrial products 105 and forward the raw data to ingestion engine 115. The devices of data source 110 may be represented by computing system 901 of FIG. 9. In addition to providing the raw data to ingestion engine 115, data source 110 may utilize the raw data for other purposes, such as runtime control of industrial products 105 and providing runtime data to operators via operator interfaces.

Ingestion engine 115 is a module configured to queue and process the raw data received from streaming data source. Ingestion engine 115 may include software operating on one or more servers or computing systems (which may be represented by computing system 901 of FIG. 9).

Ingestion engine 115 is configured to receive continuous stream of raw data from data source 110. Ingestion engine 115 may receive the raw data (e.g., runtime data or imagery) from data source 110. Once the raw data is received, ingestion engine 115 queues the data to ensure it is organized and ready for subsequent processing. Queuing the data ensures a smooth and efficient flow, preventing data loss or bottlenecks when handling large volumes of data. In addition to queuing, ingestion engine 115 processes the raw data to generate processed data. This processing includes preparing the data for ingestion in production model 135. For example, the processing may include generating feature vectors from the raw data for use as input to production model 135, for model training 130, and for model retraining 155. For example, feature vectors extracted from sensor data may include parameters such as temperature, pressure, energy consumption, flow rate, motor speed, and the like. Feature vectors extracted from imagery may include, for example, color histograms, texture, and contours. The transformation of raw data into processed data provides structured and meaningful data to provide as inputs to machine learning models, for both training and inference.

Ingestion engine 115 is further configured to provide the processed data to both model store 125 and feature store 120. Specifically, ingestion engine 115 submits the processed data to production model 135 (which is stored in model store 125) for anomaly detection. Ingestion engine 115 also stores processed data in feature store 120 for utilization in training processes, as explained further below.

Feature store 120 is a data repository storing the processed data. The processed data in feature store 120 may be stored in one or more memory devices, which may be represented by computing system 901 of FIG. 9. The processed data may include feature vectors configured to be ingested by machine learning models for training and inferences. Processed data in feature store 120 is used for model training 130 and model retraining 155, as explained further below.

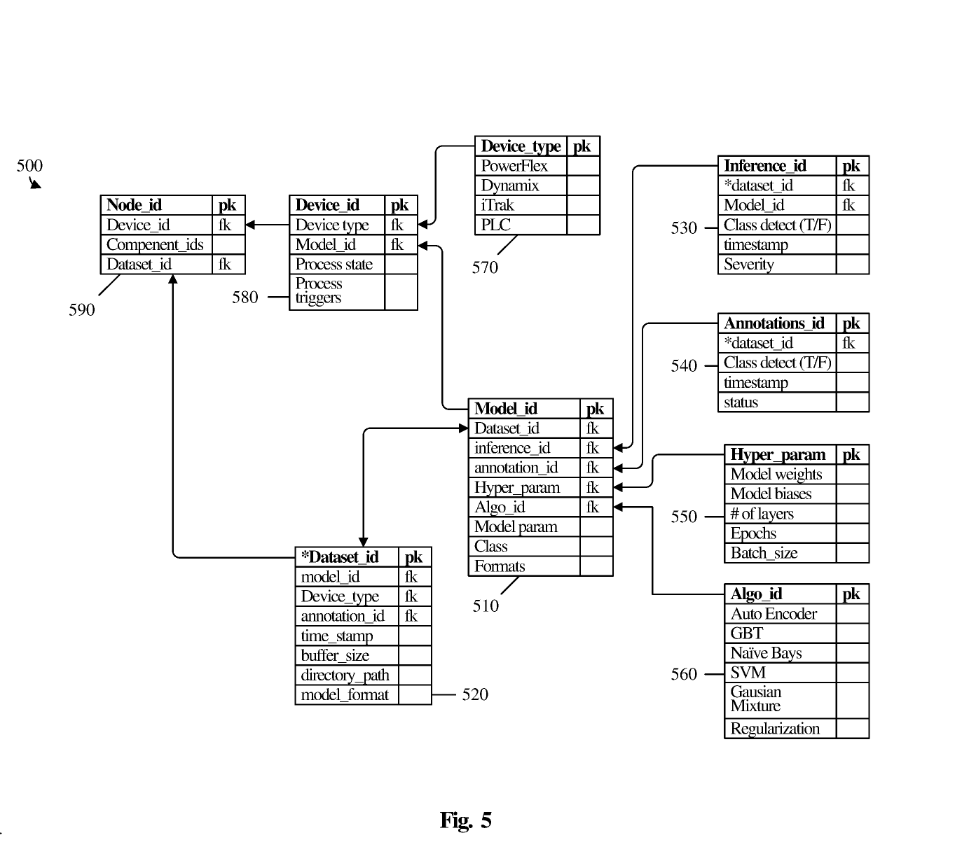

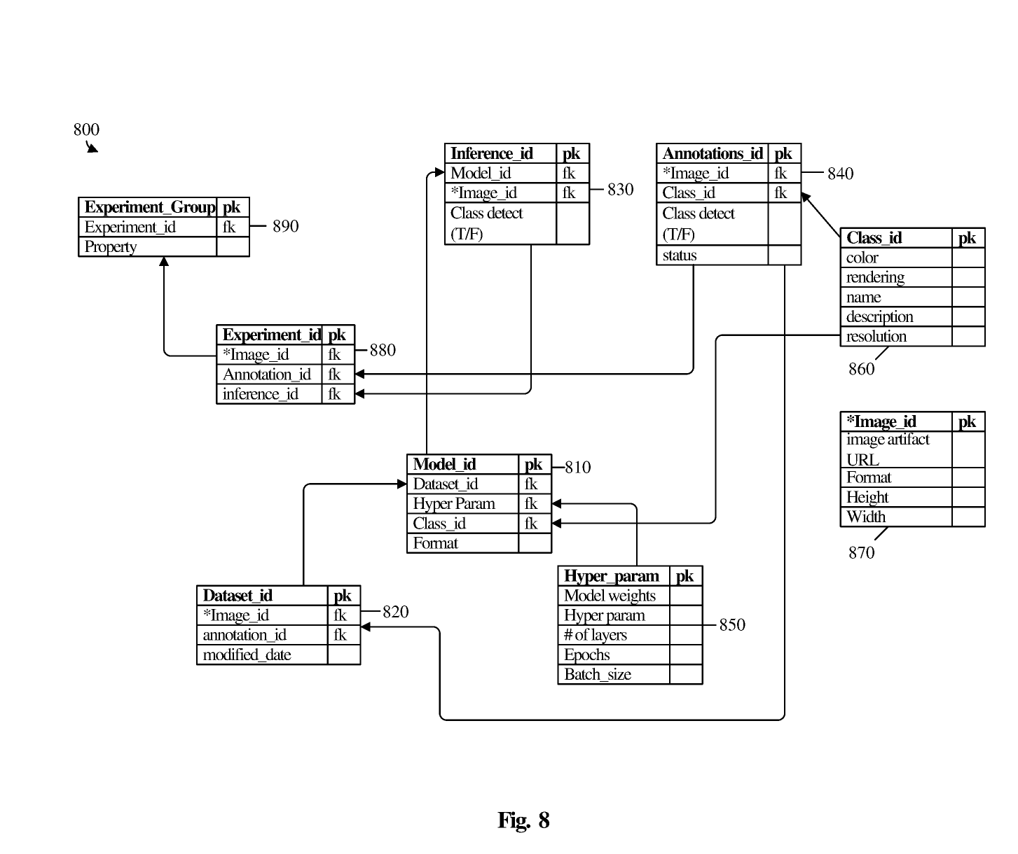

Model store 125 is a data repository storing machine learning models, including production model 135, retrained model 160, previously utilized models, and archived models (i.e., retrained models that were not promoted to production model 135). Model store 125 may also include other information associated with the machine learning models, including inferences made by the machine learning models and training annotations used to train the machine learning models. Data stored in model store may be stored in one or more memory devices, which may be represented by computing system 901 of FIG. 9. In some implementations, the various types of data in model store 125 and feature store 120 are associated in a relational database schema (such as relational database schema 500 of FIG. 5 or relational database schema 800 of FIG. 8). For example, a model in model store 125 may be associated with the processed data in feature store 120 that was used to train the model. While shown separately in machine learning operations system 100 for clarity, in some embodiments, feature store 120 and model store 125 are co-located (e.g., stored or maintained in the same data center), maintained or stored in the same hardware, or maintained or stored in the same data repository (e.g., using the same software).

The machine learning models in model store 125, such as the production model 135 and retrained model 160, are specifically designed and trained to perform inference tasks within an industrial automation environment. In some implementations, these models are anomaly detection models, leveraging runtime data or imagery from the industrial setting to identify potential issues. Typically structured as layered neural networks, these models include parameters (e.g., weights and biases), which are updated during training to enable the generation of accurate inferences.

During operation, these models receive processed data, which may include feature vectors derived from raw sensor or operational data, as discussed in the description of ingestion engine 115 above. These feature vectors encapsulate essential information that the models analyze to detect anomalies. Outputs from these models can manifest as binary indicators, such as a “True” or “False” output. A “True” output signifies the detection of an anomaly—such as potential cavitation or a risk thereof in a pump—while a “False" output indicates the absence of such anomalies based on the analyzed data. In some implementations, the outputs may also include an identification of the anomaly itself (e.g., shaft misalignment), the root cause of the anomaly (e.g., bearing failure), object identifications (in the case of image-based machine learning models).

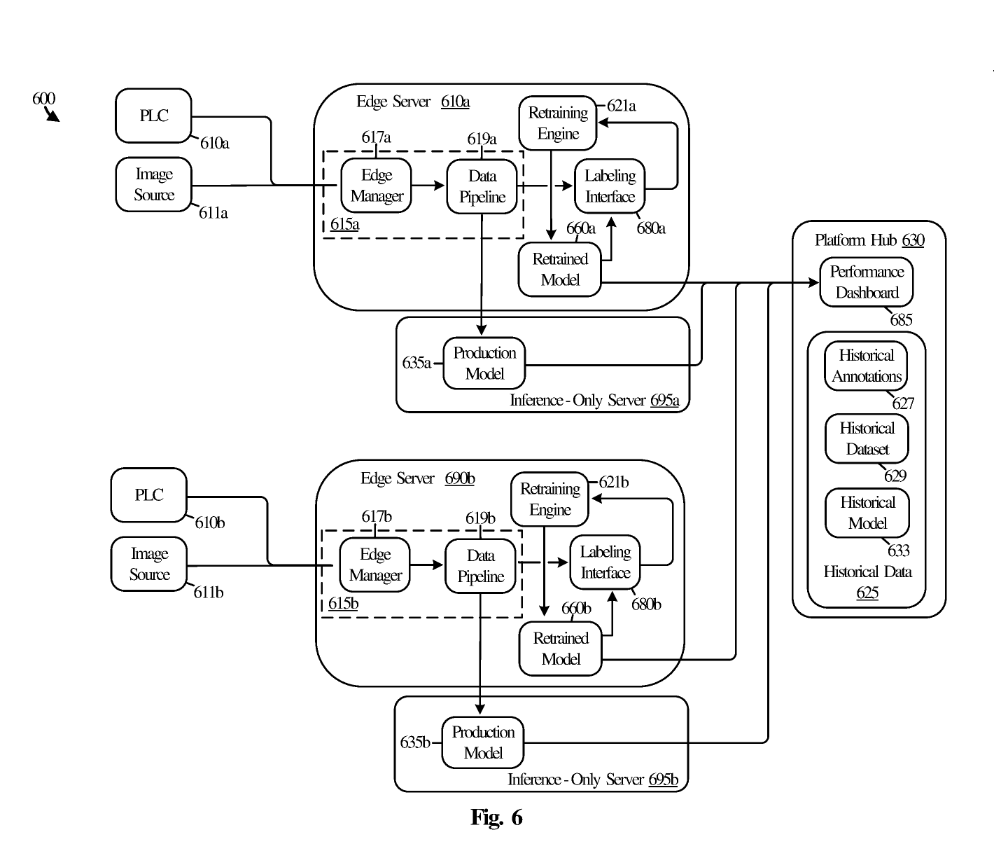

Model training 130 refers to a process of initial training to generate a machine learning model that makes inferences about the industrial automation environment. Model training 130 may be performed by a computing device executing programming instructions, such as edge server 390 of FIG. 3 and edge servers 690a, 690b of FIG. 6. Alternatively, model training 130 may be cloud-based in some implementations. In some implementations, model training 130 generates the first model that is used for a particular system. For example, when a new motor for conveyor system is brought online, a new model for detecting anomalies in the motor may be provided by model training 130. This process may involve using a base model, which may be pre-trained on general data. Model training 130 may include fine-tuning the base model with specific data from the new system or component (e.g., the new motor).

In model training 130, processed data from feature store 120 is annotated, either through automated processes or human input, to provide labeled examples that guide the model in learning the correct outputs. Once annotated, the processed data is fed into the training algorithm, which adjusts the model's parameters (e.g., weights and biases) through iterative optimization techniques. This iterative process continues until the model achieves a desired level of accuracy and performance, upon which the model may be implemented as production model 135 to detect anomalies in the industrial automation environment.

Production model 135 refers to a machine learning model that is deployed in the industrial automation environment to make real-time inferences about the industrial environment. Production model 135 may be implemented in a computing device in the industrial automation environment (e.g., inference-only server 395 of FIG. 3 or inference-only server 695 of FIG. 6). While discussed as stored in model store 125, a copy of production model 135 may be implemented in production hardware (e.g., an inference server such as inference-only server 395) as well as in a data repository (e.g., model store 125). Production model 135 detects anomalies in the industrial environment by ingesting processed data from ingestion engine 115 and generating inferences (e.g., anomaly detection inferences) about the industrial environment based on the processed data. Inferences made by production model 135 may be provided to a user via a dashboard, such as performance dashboard 385 of FIG. 3 or performance dashboard 685 of FIG. 6. Various mitigation actions may be initiated based on inferences made by production model 135. For example, if production model 135 detects one or more anomalies, mitigation actions may include providing, to a user, one or more notifications indicating the detected anomalies, halting one or more processes in the industrial automation environment, and generating a log of the detected anomalies.

Drift detection 140 refers to a process of monitoring the performance of production model 135 and detecting the occurrence of drift affecting performance of production model 135. Drift detection 140 may be performed by an edge server executing program instructions in the industrial automation environment, such as edge server 390 of FIG. 3 and edge servers 690a, 690b of FIG. 6.

Drift detection 140 includes analyzing one or both the processed data and inferences made by the production model 135 to identify data drift or model drift. Data drift occurs when there are changes in the input data distribution over time, while model drift refers to changes in the relationship between input data and output predictions. Drift detection 140 may involve statistical techniques and algorithms, such as monitoring changes in data distributions using metrics such as divergence or distance (among other metrics). It can also include monitoring the performance metrics of the model, such as accuracy or error rates, to detect significant deviations that might indicate model drift.

Retraining decision 145 involves determining whether to retrain production model 135 after drift detection 140 occurs. This decision process may be performed by a computing device executing program instructions, such as edge server 390 in FIG. 3 and edge servers 690a and 690b in FIG. 6. It is important to note that even if drift is detected by drift detection 140, production model 135 may still be performing at an acceptable level. Therefore, retraining decision 145 entails analyzing whether production model 135 is currently maintaining an acceptable performance level despite the detected drift, or if its performance has degraded to the extent that retraining is necessary to uphold performance standards. This analysis may involve automated performance assessments, human review of the model's outputs and performance metrics (such as metrics indicating the extend of data drift and/or model drift), or a combination of both.

If it is determined at retraining decision 145 that production model 135 is operating at an acceptable level of performance, machine learning operations system 100 returns to drift detection 140 to continue monitoring for model degradation. If it is determined that retraining is required, machine learning operations system 100 continues to annotation 150, as explained further below.

Annotation 150 represents a process of annotating or receiving training annotations for use in model retraining 155. Annotation 150 may be performed by a computing device executing program instructions, such as edge server 390 in FIG. 3 and edge servers 690a and 690b in FIG. 6. Alternatively, annotation 150 may be cloud-based in some implementations. Annotation 150 may involve receiving human annotations of processed data (e.g., via labeling interface 380 of FIG. 3 or labeling interfaces 680a, 680b of FIG. 6). In some implementations, annotation 150 may include automatically generating training annotations produced by algorithmic processes utilizing predefined rules or machine learning algorithms to label large datasets efficiently.

Model retraining 155 represents the process of retraining to generate an updated machine learning model. Model retraining 155 may be performed by a computing device executing program instructions, such as edge server 390 in FIG. 3 and edge servers 690a and 690b in FIG. 6. Model retraining 155 utilizes both the annotations (from annotation 150) and processed data to enhance the accuracy and performance of the updated model. Model retraining 155 utilizes the processed data stored in feature store 120. The retraining process may begin with a duplicate of production model 135 to maintain continuity and incorporate the latest operational data. Alternatively, it may start from a base model, which is a pre-trained model on general data, and then fine-tune it with the processed data and annotations.

Retrained model 160 is a machine learning model generated by model retraining 155. Retrained model 160 trained on the processed data from feature store 120 (as described in model retraining 155 above) in order to provide accurate inferences for new data distributions. Retrained model 160 is stored in model store 125. Retrained model 160 is evaluated to determine whether to promote it to production model 135, as explained further below.

Promotion decision 165 represents the process of determining whether to promote retrained model 160. This decision may be made by a computing device executing program instructions, such as edge server 390 in FIG. 3 and edge servers 690a and 690b in FIG. 6. Alternatively, promotion decision 165 may be cloud-based in some implementations. The promotion decision involves evaluating the performance of retrained model 160 by comparing it to production model 135. This evaluation may be done by humans (e.g., via the performance dashboard 385 of FIG. 3 or performance dashboard 685 of FIG. 6) or may be accomplished algorithmically, or a combination thereof in various implementations. This comparison includes assessing the performance of both models using both old and new datasets. For example, the processed data (i.e., the old dataset) and training annotations (i.e., old training annotations) used to train the production model may be retrieved from feature store 120 and model store 125, respectively, and fed into each model to compare the performance of the models with respect to the old dataset. Additionally, new annotations identified at annotation 150 and new processed data (i.e., the new dataset) from feature store 120 and associate new annotations may be used to compare the performance of the models with respect to the new dataset. Upon determining that retrained model 160 performs better on both datasets, retrained model 160 is promoted to production model 135 to make inferences in the industrial automation environment. Upon determining that retrained model 160 does not perform as well as production model 135 on either dataset, retrained model 160 is archived in model store 125. Evaluating with both old and new datasets provides a comprehensive assessment of the retrained model’s performance and its ability to make inferences across different data distributions.

Model replica 170 represents a replica of production model 135. Model replica 170 may have the same metadata, including parameter values, as production model 135. Model replica 170 stored in model store 125. Model replica 170 is created to compare, in an evaluation environment, the performance of retrained model 160 to the performance of production model 135 in some implementations. Model replica 170 provides for the evaluation of production model 135 without interfering with the real time inferences being made by production model 135.

The circled numbers in FIG. 1 represent state transitions 1 through 9 in a process flow of machine learning operations system 100. Each state transition 1 through 9 illustrates a transition from a “present state” to a “next state.” For example, state transition 1 represents a transition from model training 130 to implementation of the trained model as production model 135. State transitions 1 through 9 are condition based; meaning each transition is triggered by specific conditions, as explained further below.

State transition 1 represents the promotion of a model trained in model training 130 to production model 135. State transition 1 is triggered when a decision is made to promote the trained model to production model 135 (e.g., based on meeting performance metrics or a user input to deploy the model). At state transition 1, the model stored in model store 125 (indicating completion of the training process) and the processed data used to train the model is stored in feature store 120.

State transition 2 represents the initiation of performance monitoring for drift at drift detection 140. State transition 2 is triggered when production model 135 is fully deployed (i.e., ingesting real-time processed data from ingestion engine 115) and making real-time inferences in the industrial automation environment.

State transition 3 represents the continuing performance monitoring at drift detection 140. State transition 3 is triggered when, after drift detection, it is determined (either by a user or automatically) that model retraining is not required (e.g., since production model 135 may meet performance standards despite data drift or model drift).

State transition 4 represents the initiation of annotation 150. State transition 4 is triggered when, after drift detection, it is determined (either by a user or automatically) that model retraining is appropriate to maintain performance standards. This determination may involve generating a report with statistics about the drift and statistics about inferences made by the machine learning model based on the processed data, and providing the report to a user via a performance dashboard to help the user determine if the model has degraded below performance standards. The determination may further include receiving a user input indicating that retraining is required. Alternatively, the determination may involve automatically determining that retraining is required based on the performance metrics.

State transition 5 illustrates the initiation of model retraining 155. State transition 5 is triggered when training annotations (from annotation 150) are received. The training annotations may be submitted by a user. In some implementations, the training annotations may be automatically generated. Additionally, some implementations may utilize active learning techniques, where annotations are automatically generated and provided to a user for correction (where correction may include adding training annotations, modifying automatically generated annotations, or purging automatically generated annotations).

State transition 6 illustrates the implementation of retrained model 160 in an evaluation environment in which the performance of retrained model 160 is compared to the performance of production model 135. State transition 6 is triggered when training of retrained model 160 is complete and retrained model 160 is ready for evaluation in an evaluation environment. In state transition 6, retrained model 160 is stored in model store 125 and the processed data used for retraining is stored in feature store 120 in association with retrained model 160.

State transition 7 illustrates the initiation of promotion decision 165. State transition 7 is triggered when retrained model 160 and production model 135 have been evaluated on old and new datasets, as described above in relation to model retraining 155 above.

State transition 8 illustrates the archiving of retrained model 160 in model store 125. State transition 8 is triggered when it is determined that the performance of the retrained model 160 is degraded as compared to the production model 135.

State transition 9 illustrates the promotion of retrained model 160 to production model 135. State transition 9 is triggered when it is determined that the performance of retrained model 160 is better than the performance of the production model 135.

Performance monitoring begins for the new production model at drift detection 140. Accordingly, machine learning operations system 100 illustrates an iterative process flow, in which models are continually monitored and retrained. Each version of the model is maintained in model store 125 even after it has been replaced by a retrained model. In some implementations, models may be maintained in model store 125 indefinitely. In other implementations, older models may be removed after elapse of a predetermined time period or a predetermined number of new model deployments. The features of machine learning operations system 100 described above provide for a streamlined framework with adaptive retraining and continuous performance improvement.

Once retrained model 160 is fully deployed as production model 135, the process flow may include maintaining the previous production model in model store 125 as a checkpoint backup model. This provides the ability to revert to the previous model. For example, if a user determines that the newly implemented production model 135 is malfunctioning, the user may wish to reimplement the previous model. Accordingly, the process flow may further include determining to revert to the checkpoint backup model (i.e., the previous production model) and implementing the checkpoint backup model as production model 135 to detect anomalies.

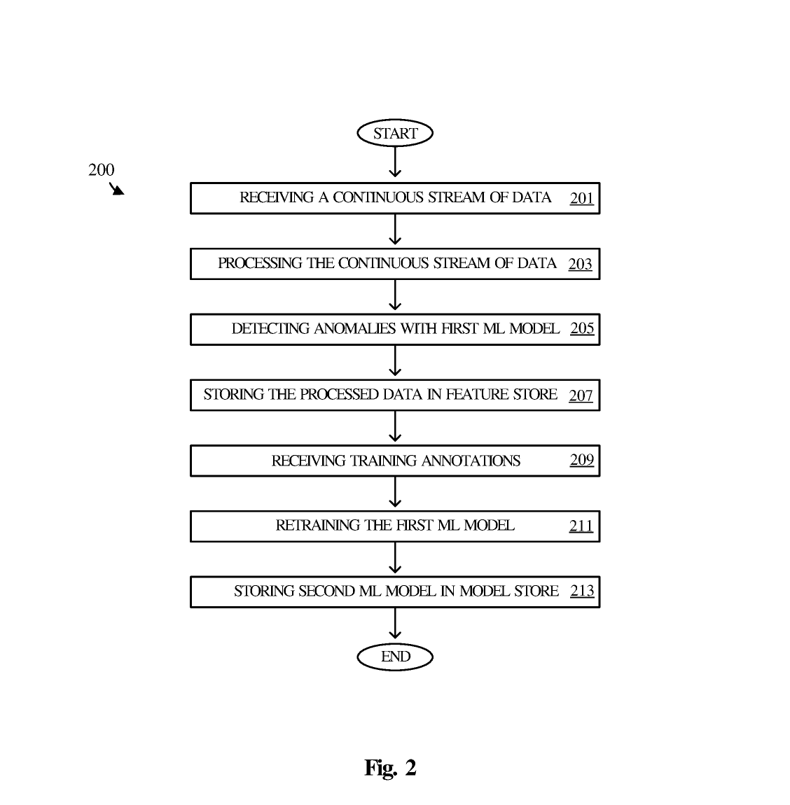

FIG. 2 illustrates process 200 for operating a machine learning operations platform. Process 200 is employed by a computing device, an example of which is provided by computing system 901 of FIG. 9. Process 200 may be implemented in program instructions (software and/or firmware) by one or more processors of the computing device. The program instructions direct the computing device to operate as follows, referring to the steps in FIG. 2.

Step 201 is receiving a continuous stream of data from an industrial device (e.g., data source 110 of FIG. 1) executing an industrial process in an industrial automation environment. In some implementations, step 201 may include receiving a continuous stream of data from multiple industrial devices, which may be represented by data source 110. The continuous stream of data may include, for example, runtime data from the industrial automation environment, or imagery from the industrial automation environment.

Step 203 is processing the continuous stream of data to generate processed data. Processing the continuous stream of data may be performed by ingestion engine 115 of FIG. 1. Processing the continuous stream of data includes preparing the continuous stream of data for ingestion by a first machine learning model (e.g., production model 135 of FIG. 1). This process may involve generating feature vectors for input into production model 135. Where the continuous stream of data is runtime data from the industrial environment, the processed data may include, for example, feature vectors representing industrial parameters such as temperature data, pressure data, flow rate data, vibration data, etc. Where the continuous stream of data is imagery of the industrial environment, the processed data may include, for example, feature vectors representing color histograms, texture, contours, and the like.

Step 205 is detecting anomalies in the continuous stream of data. The detection of anomalies includes submitting the processed data to the first machine learning model (e.g., production model 135 of FIG. 1) trained to detect anomalies in the industrial environment. The first machine learning model may detect anomalies based on processed runtime data in some implementations (e.g., to detect pump cavitation). In other implementations, the first machine learning model may be an image-based model that detects anomalies based on the processed imagery (e.g., to identify malfunctioning equipment or defective products on a factory line).

Step 207 is storing the processed data in feature store 120. As described above, the processed data from ingestion engine 115 is stored in feature store 120 for utilization in model retraining. Accordingly, the processed data is used both for anomaly detection (as described in step 205 above) and retraining.

Step 209 is receiving training annotations for the processed data (e.g., at annotation 150 of FIG. 1). These training annotations include labels for the processed data, which are used in the retraining process. The annotations may be provided by a human operator or may be automatically generated in various implementations.

Step 211 is retraining the first machine learning model (e.g., production model 135 of FIG. 1) to generate a second machine learning model (e.g., retrained model 160 of FIG. 1).

Step 213 is storing the second machine learning model (e.g., retrained model 160 of FIG. 1) in model store 125. In some implementations, model store 125 is associated with the feature store 120 in a relational database schema, and the second machine learning model is associated with the processed data in feature store 120 in the relational database schema. Exemplary relational database schemas are described in detail in the descriptions to FIGS. 5 and 8 below.

FIG. 3 illustrates industrial automation environment 300 according to some implementations. Industrial automation environment 300 includes industrial products 305, data source 310, edge server 390, and inference-only server 395. FIG. 3 illustrates an implementation in which production model 335 is implemented to detect anomalies based on runtime data in industrial automation environment 300. While specific elements of industrial automation environment 300 are shown for ease of description, industrial automation environment 300 may include more or fewer of each described component as well as other components not described for simplicity.

Industrial products 305 may be industrial products 105 of FIG. 1 according to some implementations. Industrial products 305 include products such as pumps, valves, conveyors, etc. that produce signal information (e.g., sensor data) in industrial automation environment 300.

Data source 310 includes industrial devices 311. Industrial devices may be devices such as motor drives (e.g., PowerFlex variable frequency drives), monitoring devices (e.g., Dynamix monitoring systems) or programmable logic controllers. Industrial devices 311 collect signal information from industrial products 305 and generates, from the signal data, a continuous stream of runtime data to provide to edge server 390. Data source 310 may be data source 110 of FIG. 1.

Edge server 390 is a server performing machine learning operations tasks. Edge server 390 may be deployed on premises in industrial automation environment 300, reducing the need to send and receive data from cloud platforms. Edge server 390 may be computing system 901 of FIG. 9. Edge server 390 may include memory with stored instructions carrying out the various processes described below. While one edge server 390 is shown in FIG. 3, in some implementations the machine learning operations tasks are distributed across multiple servers or computing devices.

Edge server 390 includes edge manager 317, data pipeline 319, labeling interface 380, retraining engine 321, retrained model 360, historical data 325, and performance dashboard 385.

Edge manager 317 and data pipeline 319 are included in ingestion engine 315, which may be ingestion engine 115 of FIG. 1. Edge manager 317 is configured to receive the continuous stream of runtime data from data source 310 and queues the data to ensure it is organized and ready for subsequent processing. Edge manager 317 provides the queued data to data pipeline 319. Data pipeline is configured to process the data to generate processed data. This processing includes preparing the data for ingestion in production model 335. For example, the processing may include generating feature data indicative of runtime parameters such as temperature, pressure, energy consumption, flow rate, motor speed, and the like. Data pipeline 319 forwards the processed data to production model 335 for real-time inferences, as explained further below. Data pipeline 319 also provides processed data to labeling interface 380 for retraining purposes. Additionally, data pipeline 319 may store the processed data in a feature store (such as feature store 120 of FIG. 1). Since the retraining may not occur immediately after data pipeline 319 processes the data, storing the processed data in a feature store allows the processed data to be maintained and provided to labeling interface 380 when retraining occurs.

Labeling interface 380 is an interface for receiving training annotations (e.g., at annotation 150 of FIG. 1) for the processed data. Labeling interface 380 may include providing the processed data for display to a user, who may input the training annotations for the processed data. For example, a user may input “True” to indicate that an anomaly is present in the processed data, or “False” to indicate that an anomaly is not present. In other implementations, labeling interface 380 may interface with automated systems that provide the training annotations. Once the training annotations are received at labeling interface 380, the annotated data is provided to retraining engine 321.

Retraining engine 321 is a module for retraining production model 335 (e.g., at model retraining 155 of FIG. 1). The operations of retraining engine 321 may be performed by program instructions in a memory device of edge server 390. Retraining engine 321 utilizes the annotated data from labeling interface 380 to retrain production model 335 (e.g., to address data drift and/or model drift) in order to generate retrained model 360.

Retrained model 360 is a machine learning model generated by retraining engine 321. Retrained model 360 is trained on recent processed data from data pipeline 319 to update the model (e.g., to account for data drift or model drift) to more accurately generate anomaly detection inferences from the processed runtime data. Retrained model 360 may be retrained model 160 of FIG. 1. Retrained model 360 may be evaluated on old datasets (e.g., historical dataset 329) and new datasets to ensure reliability across various data distributions.

Performance dashboard 385 represents an interface providing users with model performance information. Specifically, performance dashboard 385 may display performance metrics about retrained model 360 and production model 335. Performance metrics may include information about model accuracy (i.e., the rate at which model inferences align with the training annotations).

Historical data 325 represents historical information about previous versions of production model 335. Historical data 325 may be stored in memory of edge server 390. Historical data 325 includes historical annotations 327, historical dataset 329, and historical model 333. Historical model 333 represents a previously implemented version of production model 335. Historical model 333 may be saved in a model store, such as model store 125 of FIG. 1. While one historical model 333 is shown in FIG. 3 for simplicity, historical data 325 may include multiple historical models 333 to maintain a record of information for multiple previous versions of the model. Historical dataset 329 refers to historical processed data that was used to train historical model 333. Historical dataset 329 may be stored in a feature store, such as feature store 120 of FIG. 1. While one historical dataset 329 is shown in FIG. 3 for simplicity, historical data 325 may include multiple historical datasets 329 associated with each historical model 333. Historical annotations 327 refer to training annotations used to train historical model 333. Historical annotations 327 may also be stored in model store 125. Historical model 333 may be associated with historical dataset 329 and historical annotations 327 in relational database schema 500 of FIG. 5. Historical annotations 327 and historical dataset 329 may be utilized to evaluate the performance of retrained model 360 against performance of production model 335 (for example, as part of promotion decision 165 of FIG. 1). Using historical annotations assists in the evaluation of retrained model 360 across various data distributions.

Inference-only server 395 is a server implementing production model 335. Inference-only server 395 may be deployed on premises in industrial automation environment 300. Edge server 390 may be computing system 901 of FIG. 9. It is noted that, while production model 335 is shown in a separate server in FIG. 3, in some embodiments production model 335 may be implemented in edge server 390 (i.e., in the same server as the machine learning operations tasks). Production model 335 is a machine learning model deployed to make real-time anomaly detection inferences based on the processed runtime data from data pipeline 319. Production model 335 may be production model 135 of FIG. 1. Production model 335 provides the anomaly detection inferences to performance dashboard 685 for viewing by a user.

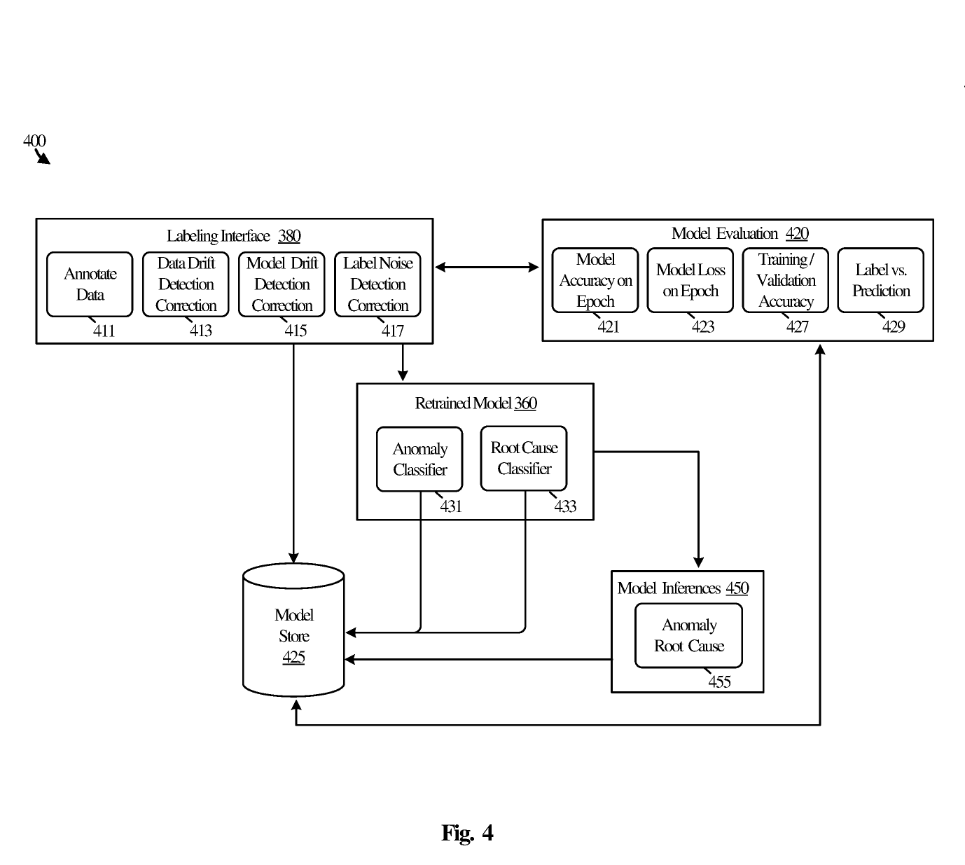

FIG. 4 illustrates training environment 400 according to some implementations, which may be implemented in edge server 390 of FIG. 3. Training environment 400 includes retrained model 360, labeling interface 380, model evaluation 420, model inference 450, and model store 425.

Retrained model 360 is described in FIG. 3 above. Retrained model 360 includes two components: anomaly classifier 431 and root cause classifier 433, according to some implementations. In some implementations, anomaly classifier 431 and root cause classifier 433 are two separate sub-models within retrained model 360. In other implementations, retrained model 360 may be a multi-task model that simultaneously makes anomaly inferences and root cause classifier. In either case, anomaly classifier 431 identifies an anomaly in an industrial environment, while root cause classifier 433 determines the root cause of the anomaly. For example, anomaly classifier 431 may identify that the speed of a motor shaft is deviating from a baseline, while root cause classifier 433 may identify that the cause of the deviation is shaft misalignment. Anomaly classifier 431 and root cause classifier 433 are stored in a model store such as model store 125 of FIG. 1.

Model inferences 450 are anomaly detection inferences made by retrained model 360 in the training process, based on processed data (e.g., from feature store 120 of FIG. 1). Model inferences 450 includes anomaly / root cause 455, which is representative of the identification of an anomaly (generated by anomaly classifier 431) and the identification of the root cause of the anomaly (generated by root cause classifier 433). Model inferences 450 are stored in model store 425 (which may be model store 125 of FIG. 1). Model inferences 450 may be associated with retrained model 360 in a relational database schema, as explained in FIG. 5 below.

Model evaluation 420 is representative of a module that evaluates retrained model 360 throughout the training process. Model evaluation 420 may be implemented by be implemented in program instructions by one or more processors of a computing device (such as edge server 390 of FIG. 3). Model evaluation 420 includes model accuracy on epoch 421, model loss on epoch 423, training / validation accuracy 427, and label vs. prediction 429.

Model accuracy on epoch 421 determines accuracy of retrained model 360 at each epoch (i.e., a pass through the training data set during training, where the training process may be an iterative process with multiple epochs). Model accuracy on epoch 421 thus tracks the model’s progress throughout the training process. Model loss on epoch 423, tracks the loss function at each epoch of training. The loss function indicates how well the model's predictions match the actual outcomes, with lower loss indicating better performance. Training / validation accuracy 427 measures the accuracy of the model on both the training and validation datasets. Using validation datasets ensures the model generalizes well to new, unseen data, not just the data it was trained on. Label vs. prediction 429 compares the model's predicted labels to the actual labels. Each of these components illustrates aspects of evaluating performance of retrained model.

Labeling interface 380 includes annotate processed data 411, data drift detection correction 413, model drift detection correction 415, and label noise detection correction 417. Annotate processed data 411 refers to an interface in which a user may annotate processed data for training (e.g., processed data from feature store 120). Data drift detection correction 413 and model drift detection correction 415 are interfaces for users to correct automated drift detections. In is noted that automated drift detectors may erroneously detect drift; accordingly, labeling interface 380 (specifically, data drift detection correction 413 and model drift detection correction 415) allows a user to correct these errors. Label noise detection correction 417 allows a user to correct inaccurate annotations (which may have occurred, for example, to human error or inaccuracies in automated annotation processes). Annotations from labeling interface 380 are provided to retrained model 360 during the training process.

Retrained model 360 may be stored in a model store 425 (e.g., model store 125 of FIG. 1) in association with annotations from labeling interface 380 and model inference 450. Relational database schema 500 of FIG. 5 is used to associate these elements, as discussed in is the discussion of FIG. 5 below. This allows a user to easily access information about the performance of retrained model (e.g., to compare the annotations from labeling interface 380 with model inferences 450).

FIG. 5 illustrates relational database schema 500 according to some embodiments. Relational database schema 500 provides an organizational structure for storing machine learning models (including production model 335, retrained model 360 and previous versions of production model 335). Relational database schema 500 provides an organizational structure for storing information associated with machine learning models, including production model 335 and retrained model 360. The information illustrated in FIG. 5 may be stored in a model store, such as model store 425 of FIG. 4. Each table in the schema has a primary key (pk) that uniquely identifies each record in the table, ensuring that each entry is distinct. Foreign keys (fk) are used to establish associations between tables.

Table 510 includes “Model_id” as the primary key. “Model_id” includes unique identifications of models stored in model store 125. Table 510 includes “Dataset_id,” “inference_id,” “annotation_id,” and “Algo_id” as foreign keys, thus associating each model in model store with the annotations and processed data used to train the respective models in model store 425 (of FIG. 4), as well as inferences made by the respective models. Table 510 also includes “Hyper-param” as a foreign key, thus associating each Model_id with the parameters that define the model stored in table 550 (as discussed below). The “Model Param” field in table 510 refer to parameters such as the learning rate, regularization coefficients, activation functions, network architecture details, dropout rate, and batch size, which define the models’ configuration and performance during training and inference. The “Class” field refers to the type or category of the model or data, indicating its specific purpose or application. The “Formats” field specifies the storage format of the model.

Table 530 includes “Inference_id” as the primary key. Table 530 includes “dataset_id” as a foreign key, thus relating the inferences with their respective datasets identified in table 520. Table 530 further includes “Model_id,” which identifies the model that made the inferences identified in table 530. Table 530 includes “Class detect (T/F),” which are anomaly detection inferences made by associated machine learning models identified in table 510 (where “T” indicates the model detected an anomaly in a dataset associated with “dataset_id,” and “F” indicates that the model did not detect an anomaly in the dataset). Table 530 further includes “timestamp,” indicating when the inferences were made, and “Severity,” which indicates the severity of the anomaly. Table 530 indicates that inferences made by models are stored in association with their respective models, as “inference_id” is a foreign key in table 530.

Table 550 includes “Hyper_param” as the primary key. Table 550 includes “Model Weights” and “Model Biases,” which are the weights and biases that govern each machine learning model’s predictive capabilities. Table 550 also includes “# of layers,” which defines the number of layers in each model’s architecture, “Epochs,” which defines how many training epochs were used to train each model, and “Batch_size,” which refers to the size of the dataset used to train the respective models.

Table 560 includes “Algo_id” as the primary key. Table 560 serves as an identifier for the specific algorithm used in the machine learning process. The “Algo_Id’ links each “Model_id” in table 510 to the machine learning technique applied, which includes various types of algorithms such as Auto Encoder and Gaussian Mixture.

Table 540 includes “Annotations_id” as the primary key. Annotations_id includes “Class Detect (T/F)” which are annotations, received via labeling interface 380, indicating whether an anomaly is present in a data set. Table 540 includes “timestamp” information indicating when each annotation was made, and “status,” which indicating validity of annotations (e.g., some annotations may be erroneous due to human or machine error). Table 540 includes “dataset_id” as a foreign key, thus linking the annotations with their respective datasets identified in table 520.

Table 520 includes “Dataset_id” as the primary key. Each Dataset_id is associated with a set of processed runtime data stored in a feature store, such as feature store 120. Table 520 includes “time_stamp,” which indicates when each data_set was created, “buffer_size,” information, which indicates the amount of data queued at each iteration from edge manager 317. Table 520, includes “directory_path” which indicates the location in storage (e.g., in feature store 120 of FIG. 1) of the processed data associated with the “Dataset_id.” Table 520 also includes “model_format,” which indicates the format of the model that the dataset is suitable for. Table 520 demonstrates that each model in model store (identified in table 510) is associated with the datasets used to train the models in relational database schema 500.

Table 590 includes “Node_id” as the primary key. “Node_id” refers to a collection of devices that produce the runtime data (e.g., data source 310 of FIG. 3). Table 590 includes “Device_id” as a foreign key, which indicates devices included in each node (e.g., data source 310 in FIG. 3 includes two industrial devices 311. Table 590 further includes “Component_ids” which identifies industrial products (e.g., industrial products 305) that are associated with the data source identified by “Node_id.” Table 590 further includes “Data_set_id” as a foreign key, associating datasets identified in table 520 with the data source that produced the raw data for the dataset.

Table 580 includes “Device_id” as the primary key, identifying the industrial devices (e.g., industrial devices 311 of FIG. 3) producing the raw data. Table 580 further includes “Device_type” as a foreign key, associating each device with a type of device (e.g., “PowerFlex” or “Dynamix” as shown in table 570). Table 580 further includes a “Process state” field indicating a state of each device (e.g., offline or online) and a “process triggers” field, indicating events or conditions in the industrial environment that cause devices to initiate actions.

Table 570 includes “Device_type” as the primary key. Table 570 includes various types of devices (e.g., Powerflex, Dynamix, etc.). As noted above, “Device_type” is a foreign key in table 580, thus associating each device with a device type.

Relational database schema 500 provides a schema providing associations for the various data types involved in machine learning operations. This allows systems and users to easily identify related information for the various types of data. For example, for any given model, whether it is production model 335, retrained model 360, or any historical model 333 (see FIG. 3), the schema allows associated information to be easily retrieved. For example, system may generate a performance report for historical model 333 by retrieving annotations used to train (foreign key “annotation_id” in table 510) and inferences made by the model (foreign key “inference_id” in table 510) using relational database schema 500. Additionally, for any given dataset (identified with primary key “Dataset_id in table 520) a user may view all the models the dataset was used to train (identified by foreign key “Model_id” in table 520). Additionally, when user wishes to view which datasets were generated by a specific data source (identified by primary key “Node_id” in table 590), relational database schema 500 allows these datasets (identified by foreign key “Dataset_id” in table 590) to be easily retrieved. Accordingly, relational database schema 500 reduces manual processes for accessing and consolidating relevant information in the operational environment.

FIG. 6 illustrates industrial automation environment 600 according to some implementations. Industrial automation environment 600 includes programmable logic controllers (PLCs) 610a, 610b, image sources 611a, 611b, edge servers 690a, 690b, inference-only servers 695a, 695b, and platform hub 630. FIG. 6 illustrates an implementation in which production models 635a, 635b are implemented to detect anomalies based on imagery of industrial automation environment 600. While specific elements of industrial automation environment 600 are shown for ease of description, industrial automation environment 600 may include more or fewer of each described component as well as other components not described for simplicity.

Programmable logic controllers (PLCs) 610a, 610b are devices that perform process control functions in industrial automation environment 600. PLCs 610a, 610b provide control signals to industrial equipment such as motor drives and receives process information (including, e.g., event logs and sensor data). PLCs 610a, 610b provide the process information to respective edge managers 617a, 617b for use in machine learning operations, as explained further below.

Image sources 611a, 611b, are cameras that capture imagery (e.g., video or photographs) in industrial automation environment 600. For example, image sources 611a, 611b may capture images of products being manufactured on a factory line, or images of industrial equipment operating in industrial automation environment 600. Image sources 611a, 611b provide the images to respective edge servers 690a, 690b for use in machine learning operations. Specifically, the images may be used for real-time anomaly detection (e.g., to identify defective products or malfunctioning equipment) and for model retraining, as discussed further below.

Edge servers 690a, 690b are servers performing machine learning operations tasks. Edge servers 690a, 690b may be deployed on premises in industrial automation environment 600, reducing the need to send and receive data from cloud platforms. Edge servers 690a, 690b, may be computing system 901 of FIG. 9. Edge servers 690a, 690b may include memory with stored instructions carrying out the various processes described in relation to edge servers 690a, 690b of FIG. 6. The two edge servers 690a, 690b demonstrate that machine learning operations tasks may be carried out separately in each edge server 690a, 690b. This allows each edge server 690a, 690b to tailor retrained machine learning models 660a, 660b to be geared specifically to the respective environment from which images and data are received. While two edge servers 690a, 690b are shown in FIG. 6 for simplicity, some implementations may include more edge servers, or only one edge server.

Edge servers 690a, 690b include respective elements ingestion engine 615a, 615b, edge manager 617a, 617b, data pipeline 619a, 619b, labeling interface 680a, 680b, retraining engine 621a, 621b, and retrained model 660a, 660b. While elements edge server 690a are described below for simplicity, the corresponding elements of edge server 690b may have substantially the same description.

In edge server 690a, edge manager 617a and data pipeline 619a are included in ingestion engine 615a, which may be ingestion engine 115 of FIG. 1. Edge manager 617a, is configured to receive a continuous stream of data, including the process information from PLC 610 and imagery (e.g., a video feed or successively captured photographs) from images source 611a. Edge manager 617a if further configured to queues the data to ensure it is organized and ready for subsequent processing. Edge manager 617a provides the queued data to data pipeline 619a. Data pipeline 619a is configured to process the data to generate processed data. This processing includes preparing the data for ingestion in production model 635a. For example, the processing of imagery from image source 611a may include identifying colors, textures, contours, and the like. The processing of process data from PLC 610a may include extracting industrial parameters such as temperature, pressure, vibration measurements, etc. Data pipeline 619a forwards the processed data to production model 635a for real-time anomaly detection inferences. Data pipeline 619a also provides processed data to labeling interface 680a for retraining purposes. Data pipeline 619a may store the processed data in a feature store (such as feature store 120 of FIG. 1). Since the retraining may not occur immediately after data pipeline 319 processes the data, storing the processed data in a feature store allows the processed data to be maintained and provided to labeling interface 680a when retraining occurs.

Labeling interface 680a is an interface for receiving training annotations (e.g., at annotation 150 of FIG. 1) for the processed data. Labeling interface 680a may include providing the processed data for display to a user, who may input the training annotations for the processed data. For example, a user may input “True” to indicate that an anomaly is present in the data (e.g., a defective product is shown by an image), or “False” to indicate that an anomaly is not present (e.g., there are no defective products shown in the image). In other implementations, labeling interface 680a may interface with automated systems that provide the training annotations. Once the training annotations are received at labeling interface 680a, the annotated data is provided to retraining engine 621a.

Retraining engine 621a is a module for retraining production model 635a (e.g., at model retraining 155 of FIG. 1). The operations of retraining engine 621a may be performed by program instructions in a memory device of edge server 690a. Retraining engine 621a utilizes the annotated data from labeling interface 680a to retrain production model 635a (e.g., to address data drift and/or model drift) in order to generate retrained model 660a.

Retrained model 660a is a machine learning model generated by retraining engine 621a. Retrained model 660a is trained on recent processed data from data pipeline 619a to update the model (e.g., to account for data drift or model drift) to more accurately generate anomaly detection inferences from the processed runtime data. Retrained model 660a may be retrained model 160 of FIG. 1. Retrained model 660a may be evaluated on old data sets (e.g., historical dataset 629) and new datasets to ensure reliability across various data distributions.

Inference-only servers 695a, 695b are server implementing production models 635a, 635b. Inference-only server 695a, 695b may be deployed on premises in industrial automation environment 600. Inference-only servers 695a, 695b may be computing system 901 of FIG. 9. It is noted that, while production models 635a, 635b are shown in separate servers in FIG. 6, in some embodiments production model 635a, 635b may be implemented in respective edge servers 690a, 690b (i.e., in the same server as the machine learning operations tasks). Production models 635a, 635b are machine learning models deployed to make real-time anomaly detection inferences based on the processed data from data pipeline 619a, 619b. For example, production models 635a, 635b may detect a defective product in an image from respective image sources 611a, 611b. Production models 635a, 635b may utilize industrial process data from PLCs 610a, 610b as contextual information for identifying defective products in images. For example, the speed of the conveyor may be relevant in interpreting images of products on the conveyor. Production models 635a, 635b may be production model 135 of FIG. 1. Production model 635a, 635b provides the anomaly detection inferences to performance dashboard 685 for viewing by a user.

Platform hub 630 is representative of a system for consolidating information from the edge servers 690a, 690b, and inference-only servers 695a, 695b in industrial automation environment 600. Platform hub 630 may be implemented in one or more computing devices, which may be represented by computing system 901 of FIG. 9. Platform hub 630 includes performance dashboard 685 and historical data 625.

Performance dashboard 685 represents an interface providing users with model performance information. Specifically, performance dashboard 685 may display performance metrics about retrained models 660a, 660b and production models 635a, 635b. Performance metrics may include information about model accuracy (i.e., the rate at which model inferences align with the training annotations).

Historical data 625 represents historical information about previous versions of production model 635a, 635b stored in a data repository of platform hub 630. Historical data 625 includes historical annotations 627, historical dataset 629, and historical model 633. Historical model 633 represents a previously implemented version of one of production models 635a, 635b. Historical model 633 may be saved in a model store, such as model store 125 of FIG. 1. While one historical model 633 is shown in FIG. 3 for simplicity, historical data 625 may include multiple historical models 633 to maintain a record of information for multiple previous versions of the model deployed in each inference-only server 695a, 695b. Historical dataset 629 refers to historical processed data that was used to train historical model 633. Historical dataset 629 may be stored in a feature store, such as feature store 120 of FIG. 1. While one historical dataset 629 is shown in FIG. 3 for simplicity, historical data 625 may include multiple historical datasets 629 associated with each historical model 633. Historical annotations 627 refer to training annotations used to train historical model 633. Historical annotations 627 may also be stored in model store 125 of FIG. 1. Historical model 633 may be associated with historical dataset 629 and historical annotations 627 in relational database schema 800 of FIG. 8. Historical annotations 627 and historical dataset 629 may be utilized to evaluate the performance of retrained models 660a, 660b against performance of production models 635a, 635b (for example, as part of promotion decision 165 of FIG. 1). Using historical annotations assists in the evaluation of retrained models 660a, 660b across various data distributions.

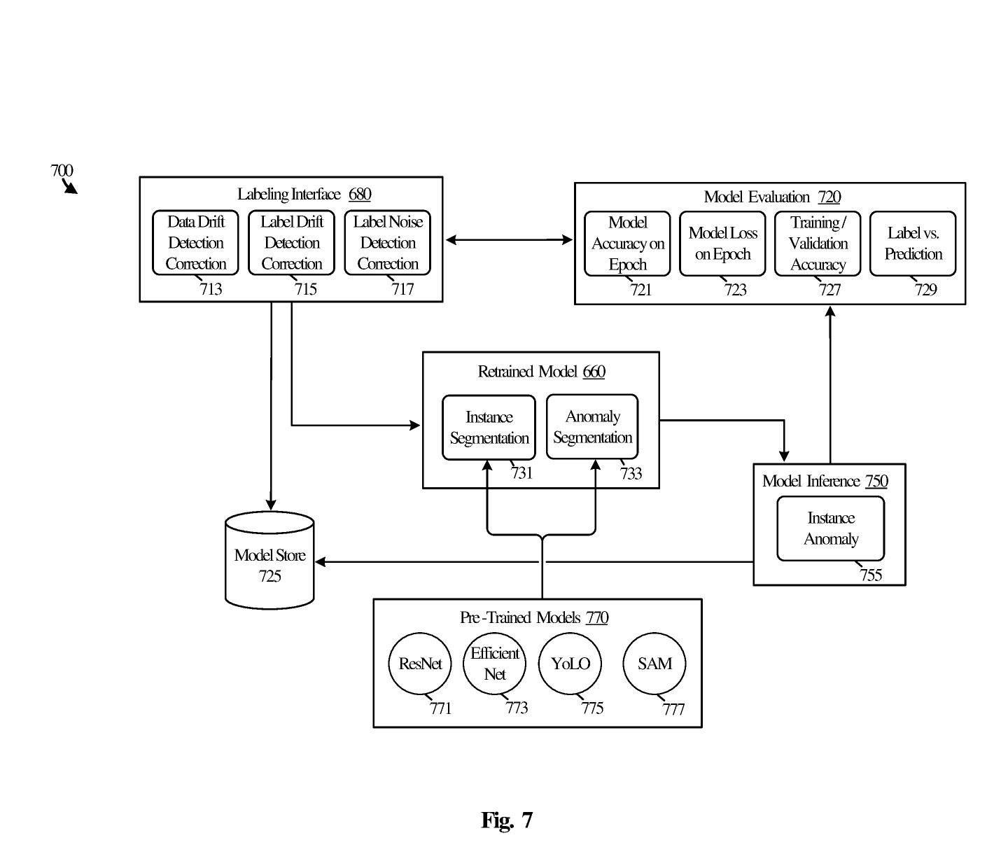

FIG. 7 illustrates training environment 700 according to some implementations, which may be implemented in an edge server 690a or 690b of FIG. 3. Training environment 700 includes retrained model 660 labeling interface 680, model evaluation 720, model inferences 750, and model store 725.

Retrained model 660 is representative of retrained models 660a, 660b, described in FIG. 6 above. Retrained model 660 includes two components: instance segmentation 731 and anomaly segmentation 733, according to some implementations. In some implementations, instance segmentation 731 and anomaly segmentation 733 are two separate sub-models within retrained model 660. In other implementations, retrained model 660 may be a multi-task model that simultaneously performs instance segmentation and anomaly segmentation functions. In either case, instance segmentation 731 identifies objects in images (e.g., identifying individual products in a factory line), while anomaly segmentation 733 detects an anomaly present in the object (e.g., a defective product).

Model inferences 750 are anomaly detection inferences made by retrained model 660 in the training process, based on processed data (e.g., from feature store 120 of FIG. 1). Model inferences 750 includes instance / anomaly 755, which is representative of the identification of an object from an image (from instance segmentation 731) and a detected anomaly (from anomaly segmentation 733). Model inferences 750 are stored in model store 725. Model inferences 750 may be associated with retrained model 660 in relational database schema 800 of FIG. 8.

Model evaluation 720 is representative of a module that evaluates retrained model 660 throughout the training process. Model evaluation 720 may be implemented by be implemented in program instructions by one or more processors of a computing device (such as edge server 690a or 690b of FIG. 6). Model evaluation 720 includes model accuracy on epoch 721, model loss on epoch 723, training / validation accuracy 727, and label vs. prediction 729.

Model accuracy on epoch 721 determines accuracy of retrained model 660 at each epoch (i.e., a pass through the training data set during training, where the training process may be an iterative process with multiple epochs). Model accuracy on epoch 721 thus tracks the model’s progress throughout the training process. Model loss on epoch 723, tracks the loss function at each epoch of training. The loss function indicates how well the model's predictions match the actual outcomes, with lower loss indicating better performance. Training / validation accuracy 727 measures the accuracy of the model on both the training and validation datasets. Using validation datasets ensures the model generalizes well to new, unseen data, not just the data it was trained on. Label vs. prediction 729 compares the model's predicted labels to the actual labels. Each of these components illustrates aspects of evaluating performance of retrained model.

Labeling interface 680 includes data drift detection correction 713, model drift detection correction 715, and label noise detection correction 717. Data drift detection correction 713 and model drift detection correction 715 are interfaces for users to correct automated drift detections. In is noted that automated drift detectors may erroneously detect drift; accordingly, labeling interface 680 (specifically, data drift detection correction 713 and model drift detection correction 715) allows a user to correct these errors. Label noise detection correction 717 allows a user to correct inaccurate annotations (which may have occurred, for example, to human error or inaccuracies in automated annotation processes). Annotations from labeling interface 680 are provided to retrained model 660 during the training process.

Retrained model 660 may be stored in a model store (e.g., model store 125 of FIG. 1) in association with annotations from labeling interface 680 and model inferences 750 (e.g., in relational database schema 800 of FIG. 8). This allows a user to easily access information about the performance of retrained model (e.g., to compare the annotations from labeling interface 680 with model inferences 750).

Pre-trained models 770 are base models that may be used as base models to generate retrained model 660. Pre-trained models 770 may include ResNet 771, Efficient Net 773, YoLO 775, and SAM 777, among other types of image-based machine learning models. These models may be fine-tuned in the training process to perform anomaly detection tasks in the industrial setting.

FIG. 8 illustrates relational database schema 800 according to some embodiments. Relational database schema 800 provides an organizational structure for storing information associated with various machine learning models in industrial automation environment 600 of FIG. 6. Relational database schema 800 provides an organizational structure for storing information associated with machine learning models, including production models 635a, 635b, retrained model 660a, 660b, and previous versions of production models 635a, 635b. The information illustrated in FIG. 8 may be stored in a model store, such as model store 725 of FIG. 7 and 125 of FIG. 1. Each table in the schema has a primary key (pk) that uniquely identifies each record in the table, ensuring that each entry is distinct. Foreign keys (fk) are used to establish associations between tables.

Table 810 includes “Model_id” as the primary key. “Model_id” includes unique identifications of models stored in model store 125. Table 810 includes “Dataset_id,” thus associating each Model_id with the datasets used to train the associated models. Table 810 also includes “Hyper Param,” as a foreign key thus associating each Model_id with the parameters that define the model stored in table 850 (as discussed below). Table 810 further includes “Class_id” as a foreign keys, thus correlating each model with the class of images that each model is trained to generate inferences for. Table 810 also includes "Format” specifying the storage format of the model.

Table 860 includes “Class_id” as the primary key. Table 860 identifies various characteristics for classes of images. Table 860 includes “color” identifying color characteristics of the class of images, “rendering” identifying the rendering style for images in the class, “name” identifying a name or label for the class, “description” including a textual description of images in the class, and “resolution” identifying the resolution of images in the class.

Table 820 includes “Dataset_id” as the primary key. Each Dataset_id is associated with a set of images stored in a feature store, such as feature store 120. Table 820 includes “Image_id” as a foreign key, identifying individual images in the dataset (where image data is stored in table 870 and described further below). Table 820 further includes “annotation_id” as a foreign key, thus associating datasets with training annotations for the datasets in table 840. Table 820 includes “modified_date,” indicating the date of the last update to the dataset.

Table 870 includes “Image_id” as the primary key, identifying individual images taken by images sources 611a, 611b (see FIG. 6). Table 870 includes an “image artifact URL” field which identifies a file location of features extracted from the images during pre-processing (which may be stored in a feature store such as feature store 120 of FIG. 1). Table 870 further includes a “Format” field, indicating the format of the associated image file, and a “height” field and “width” field, indicating the height and width of the image.

Table 830 includes “Inference_id” as the primary key. Table 830 includes “model_id” as a foreign key, thus associating the inferences with the machine learning model that generated the inferences. Table 830 further includes “image_id” as a foreign key, thus linking the inferences with the images that the inferences were generated for. Table 830 further includes a “Class detect” field, (where “T” indicates the model detected an anomaly in the image” and “F” indicates that the model did not detect an anomaly in the image).

Table 850 includes “Hyper_param” as the primary key. Table 850 includes a “Model Weights” field and a “Model Biases” field for the weights and biases that govern each machine learning model’s predictive capabilities. Table 580 also includes a “# of layers,” field which defines the number of layers in each model’s architecture, an “Epochs” field, which defines how many training epochs were used to train each model, and a “Batch_size” field, which refers to the number of images used to train each model.

Table 840 includes “Annotations_id” as the primary key. Table 840 includes “Image_id” as a foreign key, thus associating the training annotations with the images they were provided for. Table 540 further includes “Class_id” as a foreign key, associating the annotations with the class of image that the annotation was provided for. Table 840 further includes a “Class Detect (T/F)” field for the annotations indicating whether or not an anomaly is present in the images. Table 540 further includes a “status” field, which indicating validity of annotations (e.g., some annotations may be erroneous due to human or machine error).

Table 880 includes “Experiment_id” as the primary key. Table 880 includes “Image_id,” “Annotation_id,” and “inference_id” as foreign keys, thus association model inferences and training annotations for the images.

Table 890 includes “Experiment_group” as the primary key. Table 890 also includes “Experiment_id” as a foreign key and a “Property” field, indicating whether the inferences made by the model for the associated Experiment_id was successful (i.e., whether it matched the training annotation). The use of tables 880 and 890 in relational database schema 800 consolidates performance information about each machine learning model.

FIG. 9 illustrates computing system 901, which is representative of any system or collection of systems in which the various applications, processes, services, and scenarios disclosed herein may be implemented. Examples of computing system 901 include, but are not limited to server computers, web servers, cloud computing platforms, and data center equipment, microcontrollers, micro-controller units (MCUs), as well as any other type of physical or virtual server machine, container, and any variation or combination thereof. (In some examples, computing system 901 may also be representative of desktop and laptop computers, tablet computers, and the like.)

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements machine learning operations processes 906, which are representative of the processes discussed with respect to the preceding figures, such as process 200. When executed by processing system 902, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may include a microprocessor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, microcontroller units, graphical processing units, application specific processors, integrated circuits, application specific integrated circuits, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 903 may be implemented as a single storage device but may also be implemented across multiple storage devices or sub-systems co-located or distributed relative to each other. Storage system 903 may comprise additional elements, such as a controller capable of communicating with processing system 902 or possibly other systems.

Software 905 (including machine learning operations processes 906) may be implemented in program instructions and among other functions may, when executed by processing system 902, direct processing system 902 to operate as described with respect to the various operational scenarios, sequences, and processes illustrated herein. For example, software 905 may include program instructions for implementing machine learning operations processes and procedures as described herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof.

Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or" in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for operating a machine learning operations platform, the computer-implemented method comprising:
receiving a continuous stream of data from an industrial device executing an industrial process in an industrial automation environment;
processing the continuous stream of data to generate processed data, wherein the processing comprises preparing the continuous stream of data for ingestion by a first machine learning model;
detecting anomalies in the continuous stream of data, wherein the detecting comprises:
submitting the processed data to the first machine learning model trained to detect the anomalies in the industrial automation environment, wherein the first machine learning model is stored in a model store;
storing the processed data in a feature store;
receiving training annotations for the processed data;
retraining, using the processed data from the feature store and the training annotations, the first machine learning model to generate a second machine learning model; and
storing the second machine learning model in the model store, wherein:
the model store is associated with the feature store in a relational database schema, and
the second machine learning model is associated with the processed data in the relational database schema.

2. The computer-implemented method of claim 1, further comprising:
storing the training annotations in the model store, wherein:
the training annotations are associated with the second machine learning model in the relational database schema,
the training annotations comprise new training annotations,
the first machine learning model is associated with old training annotations in the relational database schema, and
the old training annotations are used to train the first machine learning model; and
evaluating the second machine learning model, the evaluating comprising:
comparing a performance of the first machine learning model to a performance of the second machine learning model based on the old training annotations, and
comparing the performance of the first machine learning model to the performance of the second machine learning model based on the new training annotations.

3. The computer-implemented method of claim 2, further comprising:
determining, based on the evaluating the second machine learning model, that the second machine learning model performs better than the first machine learning model; and
promoting the second machine learning model, wherein the promoting comprises detecting the anomalies in the continuous stream of data with the second machine learning model.

4. The computer-implemented method of claim 3, further comprising;
maintaining, in response to the promoting the second machine learning model, the first machine learning model in the model store as a checkpoint backup model;
determining to revert to the checkpoint backup model; and
reverting to the checkpoint backup model, wherein the reverting the checkpoint backup model comprises detecting the anomalies in the continuous data stream with the first machine learning model.

5. The computer-implemented method of claim 1, further comprising:
determining that a performance of the first machine learning model has degraded, wherein the retraining is in response to the determining that the performance of the first machine learning model has degraded.

6. The computer-implemented method of claim 5, wherein the determining that the performance of the first machine learning model has degraded comprises:
detecting drift based at least in part on the processed data, wherein the drift comprises one or both of model drift and data drift.

7. The computer-implemented method of claim 6, further comprising:
generating a report with statistics about the drift and statistics about inferences made by the first machine learning model based on the processed data; and
providing the report to a user via a performance dashboard.

8. The computer-implemented method of claim 1, further comprising:
receiving, from the first machine learning model, anomaly detection inferences based on the processed data; and
storing the anomaly detection inferences in the model store, wherein the anomaly detection inferences as associated with the first machine learning model in the relational database schema.

9. The computer-implemented method of claim 1, further comprising:
performing a mitigation action in response to detecting the anomalies, wherein the mitigation action comprises one or more of:
providing, to a user, one or more notifications indicating the detected anomalies,
halting one or more processes in the industrial automation environment, and
generating a log of the detected anomalies.

10. The computer-implemented method of claim 1, wherein the model store and the feature store are disposed in a computing system located in the industrial automation environment, and wherein the computing system performs the computer-implemented method.

11. The computer-implemented method of claim 1, wherein the continuous stream of data comprises one of runtime data generated by the industrial device, and images captured by the industrial device.

12. A machine learning operations system comprising:
one or more processors; and
one or more memories operably coupled to the one or more processors and having stored thereon software instructions that, upon execution by the one or more processors, cause the one or more processors to:
receive a continuous stream of data from an industrial device executing an industrial process in an industrial automation environment;
process the continuous stream of data to generate processed data, wherein the processing comprises preparing the continuous stream of data for ingestion by a first machine learning model;
detect anomalies in the continuous stream of data, wherein the detecting comprises:
submitting the processed data to the first machine learning model trained to detect the anomalies in the industrial automation environment, wherein the first machine learning model is stored in a model store;
store the processed data in a feature store;
receive training annotations for the processed data;
retrain, using the processed data from the feature store and the training annotations, the first machine learning model to generate a second machine learning model; and
store the second machine learning model in the model store, wherein:
the model store is associated with the feature store in a relational database schema, and
the second machine learning model is associated with the processed data in the relational database schema.

13. The machine learning operations system of claim 12, wherein the software instructions comprise further instructions that, upon execution by the one or more processors, cause the one or more processors to:
store the training annotations in the model store, wherein:
the training annotations are associated with the second machine learning model in the relational database schema,
the training annotations comprise new training annotations,
the first machine learning model is associated with old training annotations in the relational database schema, and
the old training annotations are used to train the first machine learning model; and
evaluate the second machine learning model by:
comparing a performance of the first machine learning model to a performance of the second machine learning model based on the old training annotations, and
comparing the performance of the first machine learning model to the performance of the second machine learning model based on the new training annotations.

14. The machine learning operations system of claim 13, wherein the software instructions comprise further instructions that, upon execution by the one or more processors, cause the one or more processors to:
determine, based on the evaluation of the second machine learning model, that the second machine learning model performs better than the first machine learning model; and
promote the second machine learning model, wherein the promoting comprises detecting the anomalies in the continuous data stream with the second machine learning model.

15. The machine learning operations system of claim 14, wherein the software instructions comprise further instructions that, upon execution by the one or more processors, cause the one or more processors to:
maintain, in response to the promoting the second machine learning model, the first machine learning model in the model store as a checkpoint backup model;
determine to revert to the checkpoint backup model; and
revert to the checkpoint backup model, wherein the reverting the checkpoint backup model comprises detecting the anomalies in the continuous data stream with the first machine learning model.

16. The machine learning operations system of claim 12, wherein the software instructions comprise further instructions that, upon execution by the one or more processors, cause the one or more processors to:
determine that a performance of the first machine learning model has degraded, wherein:
the retraining is in response to the determining that the performance of the first machine learning model has degraded, and
the determining that the first machine learning model has degraded comprises detecting drift based at least in part on the processed data.

17. The machine learning operations system of claim 16, wherein the software instructions comprise further instructions that, upon execution by the one or more processors, cause the one or more processors to:
generate a report with statistics about the drift and statistics about inferences made by the first machine learning model based on the processed data; and
provide the report to a user via a performance dashboard.

18. The machine learning operations system of claim 12, wherein the software instructions comprise further instructions that, upon execution by the one or more processors, cause the one or more processors to:
receive, from the first machine learning model, anomaly detection inferences based on the processed data; and
store the anomaly detection inferences in the model store, wherein the anomaly detection inferences as associated with the first machine learning model in the relational database schema.

19. The machine learning operations system of claim 12, wherein the software instructions comprise further instructions that, upon execution by the one or more processors, cause the one or more processors to:
perform a mitigation action in response to detecting the anomalies, wherein the mitigation action comprises one or more of:
providing, to a user one or more notifications indicating the detected anomalies,
halting one or more processes in the industrial automation environment, and
generating a log of the detected anomalies.

20. The machine learning operations system of claim 12, wherein the continuous stream of data comprises one of runtime data generated by the industrial device, and images captured by the industrial device.
